(19) United States
(12) Patent Application Publication
(10) Pub. No.: US 2006/0144473 A1
(43) Pub. Date: Jul. 6, 2006

(54) Doped Gd5Ge2Si2 compounds and methods for reducing hysteresis losses in Gd5Ge2Si2 compound

(76) Inventors: Robert D. Shull, Boyds, MD (US); Alexander J. Shapiro, Rockville, MD (US); Virgil Provenzano, Gaithersburg, MD (US)

Correspondence Address: Kermit Lopez;Ortiz & Lopez, PLLC, Registered Patent Attorneys, P.O. Box 4484, Albuquerque, NM, 87196, US

(21) Appl. No.: 11/262,270

(22) Filed: Oct. 27, 2005

Related U.S. Application Data
(60) Provisional application No. 60/641,168, filed on Jan. 4, 2005.

(51) Int. Cl. H01F 1/00

(52) U.S. Cl. 148/121; 148/300

(57) ABSTRACT

A Gd₅Ge₂Si₂ refrigerant compound is doped or alloyed with an effective amount of silicide-forming metal element such that the magnetic hysteresis losses in the doped Gd₅Ge₂Si₂ compound are substantially reduced in comparison to the hysteresis losses of the undoped Gd₅Ge₂Si₂ compound. The hysteresis losses can be nearly eliminated by doping the Gd₅Ge₂Si₂ compound with iron, cobalt, manganese, copper, or gallium. The effective refrigeration capacities of the doped Gd₅Ge₂Si₂ compound are significantly higher than for the undoped Gd₅Ge₂Si₂ compound.

### REFERENCE TO RELATED APPLICATION

This patent application claims priority under 35 U.S.C. § 119(e) to provisional patent application Ser. No. 60/641,168 entitled “Near-Elimination of Large Hysteresis Losses in the Gd₅Ge₂Si₂ Alloy by Small Silicide Forming Metal Addition Resulting in a Much Improved Magnetic Refrigerant Material” which was filed on Jan. 4, 2005, the disclosure of which is incorporated herein by reference provisional patent application.

### TECHNICAL FIELD

Embodiments are generally related to magnetic refrigerant compounds and, in particular, to Gd—Ge—Si containing compounds. Embodiments are also related to methods of preparing Gd₅Ge₂Si₂ doped alloys. Embodiments are additionally related to methods of reducing hysteresis losses in the Gd₅Ge₂Si₂ compound.

### BACKGROUND OF THE INVENTION

Magnetic refrigeration is in principle a much more efficient technology than conventional vapor compression refrigeration technology as it is a reversible process and, moreover, it does not use environmentally unfriendly ozone-depleting chlorofluorocarbon refrigerants (CFCs). Magnetic refrigeration depends on the magnetocaloric effect (MCE), utilizing the entropy of magnetic spin alignment for the transfer of heat between reservoirs.

Since the late nineties, the use of a Gd₅Ge₂Si₂ compound in near-room temperature magnetic refrigeration applications has attracted attention owing to its potential as a suitable refrigerant material for near room temperature magnetic refrigeration. A large magnetocaloric effect in the Gd₅Ge₂Si₂ compound in the 270-300 K temperature range has been reported by Gschneidner, Pecharsky and their coworkers in the following published references: Pecharsky, V. K. & Gschneidner, K. A., Jr., “The Giant Magnetocaloric Effect in Gd₅(Ge₂Si₂)”, Phys. Rev. Lett. 78, 4494-4497 (1997), Pecharsky, A. O., Gschneidner, K. A., Jr., “The Giant Magnetocaloric Effect of Optimally Prepared Gd₅Ge₂Si₂”, J. Appl. Phys. 93, 4722-4728 (2003), and Pecharsky, V. K. & Gschneidner, K. A., Jr “The Giant Magnetocaloric Effect in Gd₅(SiₓGe₁₋ₓ)₄ Materials for Magnetic Refrigeration”, Advances in Cryogenic Engineering, 43, edited by P. Kittel, Plenum Press, New York, 1729-1736 (1998).

The aforementioned references disclosed that the large magnetocaloric effect observed in the Gd₅Ge₂Si₂ compound, in the 270-320 K temperature range, is the result of a magnetic field-induced crystallographic phase change from the high-temperature paramagnetic monoclinic phase to the low-temperature ferromagnetic orthorhombic phase. Unfortunately, large hysteresis losses were also observed in the Gd₅Ge₂Si₂ magnetic refrigerant compound in the 270-320 K temperature range. These large hysteretic losses occurred at the same temperature range where the compound exhibits a pronounced magnetocaloric effect, referred as “The giant magnetocaloric effect”.

Choe, W. et al, and other researchers have proposed that the large magnetocaloric effect is the result of a field-induced crystallographic phase change from the high temperature paramagnetic monoclinic phase to the low-temperature ferromagnetic orthorhombic phase (see Choe, W. et al, “Making and Breaking Covalent Bonds across the Magnetic Transition in the Giant Magnetocaloric Material Gd₅(Ge₂Si₂)”, Phys. Rev. Left. 84, 4617-4620 (2000), Pecharsky, V. K. & Gschneidner, K. A., Jr., “Phase relationship and crystallography in pseudobinary system Gd₅Si₄—Gd₅Ge₄”, J. Alloys and Compd. 260, 98-106 (1997), and Pecharsky, V. K., Pecharsky, A. O., and Gschneidner, K. A., Jr., “Uncovering the structure-property in Rₛ(SiₓGe₄₋ₓ) intermetallics phases”, J. Alloys and Compd. 344, 362-368 (2002).)

Other studies by Pecharsky et al and by other researchers have also observed the magnetocaloric effect of the Gd₅Ge₂Si₂ magnetic refrigerant compound and the hysterisis losses behavior (See Pecharsky, V. K. & Gschneidner, K. A., Jr. “Tunable magnetic regenerator alloys with a giant magnetocaloric effect for magnetic refrigeration from 20 to 290 K”, Appl. Phys. Lett. 70, 3299-3301 (1997), Levin, E. M., Pecharsky, V. K., and Gschneidner, K. A., Jr. “Unusual magnetic behavior in G₅(Ge_{1.5}Si_{2.5}) and G₅Ge₂Si₂”, Phys. Rev. B 62, RI4 625-R14 628 (2000), Giguere, A. et ai. Direct Measurements of the ‘Giant’ Adiabatic Temperature, Change in G₅Ge₂Si₂”, Phys. Rev. Left. 83, 2262-2265 (1999).

There is a need to greatly reduce or eliminate the large hysteresis losses in the G₅Ge₂Si₂ compound so that the potential of the compound as an efficient and attractive refrigerant material for near-room temperature magnetic refrigeration can be fully realized.

The embodiments disclosed herein therefore directly address the shortcomings of present Gd₅Ge₂Si₂ magnetic refrigerant compounds, providing an alloy that is suitable for near-room temperature magnetic refrigeration applications.

### BRIEF SUMMARY

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for an improved magnetic refrigerant material.

It is another aspect of the present invention to provide for a Gd—Ge—Si containing alloy suitable for near-room temperature magnetic refrigeration applications.

It is a further aspect of the present invention to provide for a method of preparing a doped Gd₅Ge₂Si₂ alloy.

It is yet an additional aspect of the present invention to provide for a method of reducing large hysterisis losses in the Gd₅Ge₂Si₂ containing alloy.

The aforementioned aspects of the invention and other objectives and advantages can now be achieved as described herein.

In one aspect, a method of reducing hysterisis in a Gd₅Ge₂Si₂ refrigerant compound is provided. The Gd₅Ge₂Si₂ compound is doped or alloyed with an effective amount of a silicide-forming metal element such that the magnetization hysterisis losses in the doped Gd₅Ge₂Si₂ compound are substantially reduced in comparison to the hysterisis losses of the undoped Gd₅Ge₂Si₂ compound. By adding a silicide-forming metal to the Gd₅Ge₂Si₂ compound in this manner, a magnetic refrigerant material highly suitable for near-room temperature applications is provided.

About one atomic percent of said silicide-forming metal can be added to the Gd₅Ge₂Si₂ compound in order to reduce hysteresis losses by more than 90 percent compared to the undoped Gd₅Ge₂Si₂ compound. Additionally, the resulting doped Gd₅Ge₂Si₂ compound exhibits significantly higher calculated effective refrigerant capacities than the Gd₅Ge₂Si₂ compound without silicide-forming metal additives.

The silicide-forming metal element can comprise at least one metal selected from a group of materials that includes one or more of the following: iron (Fe), cobalt (Co), manganese (Mn), copper (Cu), or gallium (Ga). When the silicide-forming metal element consists of Mn, Cu, or Ga, the hysterisis losses are reduced by near 100 percent, that is, the hysterisis losses are nearly eliminated.

In another aspect, the Gd₅Ge₂Si₂ compound alloyed with the silicide-forming metal additive is prepared by means of arc melting mixtures of the compound elements and silicide-forming metal element. The Gd₅Ge₂Si₂ compound alloyed with the silicide-forming metal additive is then heat treated so as to homogenize the compound.

In yet another aspect, there is provided a magnetic refrigerant alloy of the general formula: Gd₅Ge_{1-X}Si₂M_{X}, wherein M is a silicide-forming metal element; and wherein x is an effective number selected such that hysterisis loss in the alloy is substantially smaller than when x=0.

X can be about 0.1. M can be at least one metal selected from the group consisting of Fe, Co, Mn, Cu, or Ga.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1(a) depicts a backscattered SEM micrograph of a typical microstructure of the Gd₅Ge₂Si₂ alloy heat treated in vacuum at 1300° C. for 1 hour;

FIGS. 1(b) and 1(c) depict backscattered SEM micrographs of the Gd₅Ge_{0.9}Si₂Fe_{0.1} alloy heat treated in vacuum at 1300° C. for 1 hour according to one embodiment;

FIGS. 2 (a) to (d) respectively depict backscattered SEM micrographs of the Gd₅Ge₂Si₂ compound doped with cobalt, copper, gallium, and manganese according to different embodiments;

FIG. 3 depicts a graph of magnetization versus field loops of the Gd₅Ge₂Si₂ compound heat treated in vacuum at 1300° C. for 1 hour;

FIG. 4 depicts a graph of magnetization versus field loops of the Gd₅Ge_{1.9}Si₂Fe_{0.1} alloy heat treated in vacuum at 1300° C. for 1 hour;

FIGS. 5(a)-5(d) depict graphs of magnetization versus field loops of the Gd₅Ge_{1.9}Si₂Mn_{0.1}, Gd₅Ge_{1.9}Si₂Ga_{0.1}, Gd₅Ge_{1.9}Si₂Cu_{0.1} and Gd₅Ge_{1.9}Si₂Co_{0.1} alloy samples heat treated in vacuum at 1300° C. for 1 hour;

FIG. 6 depicts a graph of computed magnetic entropy change, ΔSm, versus temperature, integrated over applied field ΔH=3980 KA/m (5 T), of the Gd₅Ge₂Si₂ compound heat treated in vacuum at 1300° C. for 1 hour,

FIG. 7 depicts a graph of computed magnetic entropy change, ΔSm, versus temperature, integrated over applied field ΔH=3980 KA/m (5 T), of the Gd₅Ge_{1.9}Si₂Fe_{0.1} compound heat treated in vacuum at 1300° C. for 1 hour,

FIG. 8 illustrates computed magnetic entropy change, ΔSm, versus temperature of different Gd₅Ge_{1.9}Si₂M_{0.1} alloys, wherein M=Co, Mn, Cu, or Ga, heat treated in vacuum at 1300° C. for 1 hour; and

FIG. 9 depicts a table of computed Refrigeration Capacity (RC) and corresponding Effective Refrigeration Capacity (ERC) values for the compound Gd₅Ge₂Si₂ doped with different metal additives.

### DETAILED DESCRIPTION OF THE INVENTION

The particular values and configurations discussed in these non-limiting examples can be varied and are cited merely to illustrate at least one embodiment and are not intended to limit the scope of the invention.

The method for reducing the hysteresis losses in the Gd₅Ge₂Si₂ refrigerant compound consists of alloying or doping the Gd₅Ge₂Si₂ compound with either a small amount of either iron or other silicide-forming metal additive, such as manganese, cobalt, copper, or gallium.

As will be described in more detail below, alloying the compound with a very small amount of the silicide-forming metal additive, results in the reduction of the hysteresis losses by more than 90 percent and for some of the metal additives, the reduction is nearly 100 percent.

For the purpose of discussion hereinafter, the term “metal additive” refers to iron or other silicide-forming metal additive.

According to one embodiment, the Gd₅Ge₂Si₂ refrigerant compound doped or alloyed with iron was prepared by arc melting the appropriate elemental mixtures, using a water-cooled copper hearth in an argon atmosphere under ambient pressure. The purity of the starting constituents was 99.9 wt. % and the chemical composition of the alloy resulting doped compound was Gd₅Ge_{1.9}Si₂Fe_{0.1}. Also for the purpose of comparison, a Gd₅Ge₂Si₂ refrigerant compound was prepared by the same arc melting process but without the metal additive. Prior to making magnetic measurements, using a SQUID magnetometer, each alloy was homogenized for one hour at 1300° C. in vacuum.

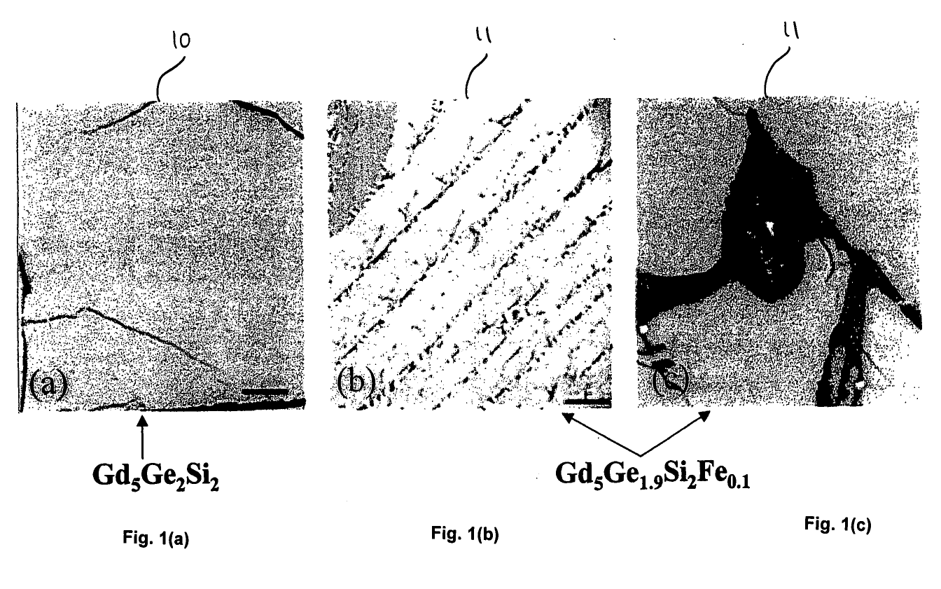

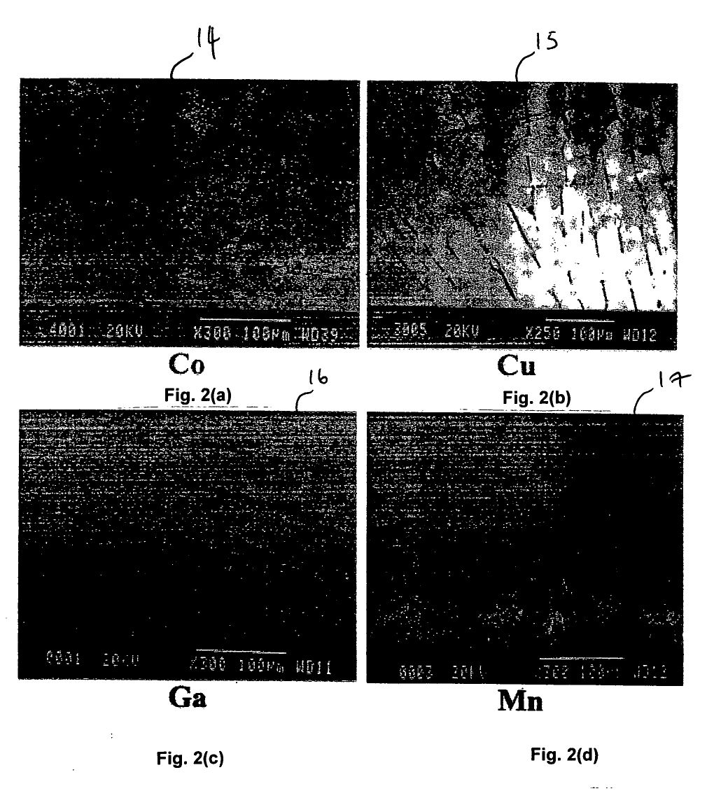

Referring to FIG. 1(a) of the accompanying drawings, which depicts, a backscattered SEM micrograph of a typical microstructure of the heat treated Gd₅Ge₂Si₂ compound, and FIGS. 1(b) & 1(c), which depict backscattered SEM micrographs of the heat treated Gd₅Ge_{1.9}Si₂Fe_{0.1} alloy according to one embodiment, the micrographs show that the Gd₅Ge₂Si₂ compound 10 is single phase, whereas the Gd₅Ge_{1.9}Si₂Fe_{0.1} alloy 11 is multiphase, with a dominant light gray phase surrounded by a darker minor intergranular phase.

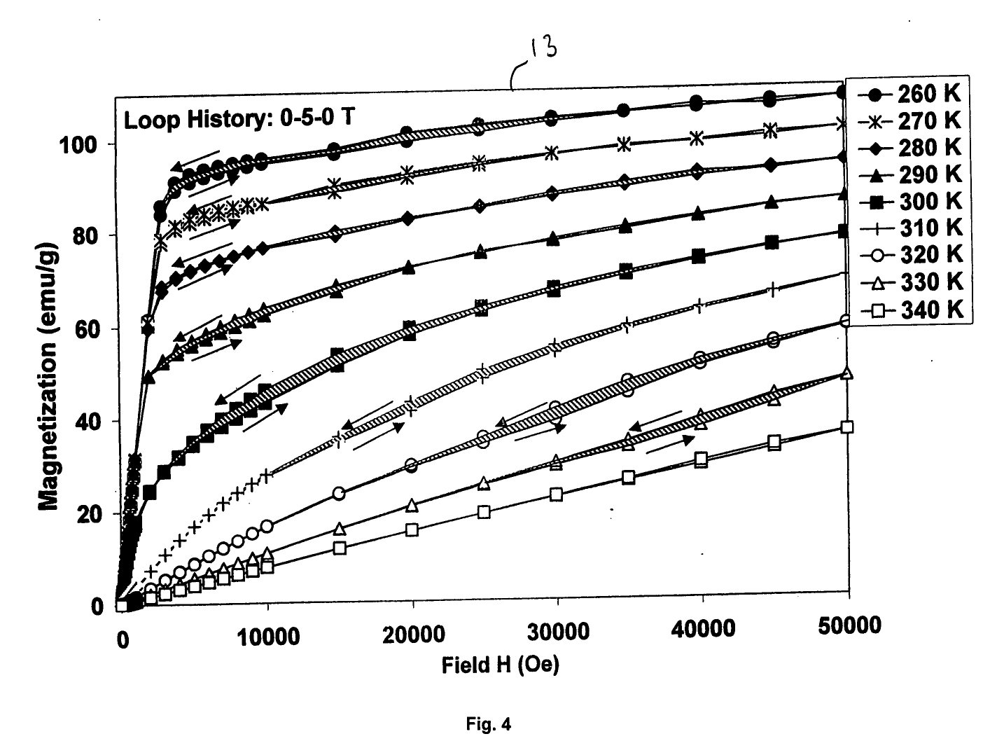

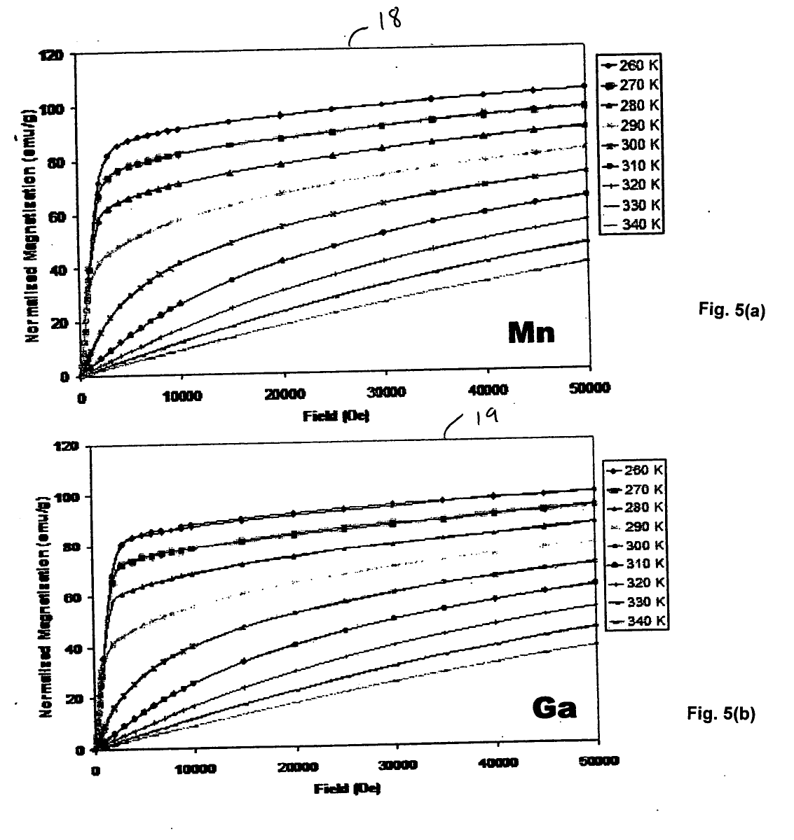

FIGS. 3 and 4 respectively depict graphs of magnetization versus field loops 12, 13 of the heat treated Gd₅Ge₂Si₂ compound 10 and of the heat treated Gd₅Ge_{1.9}Si₂Fe_{0.1} compound 11. The hysteresis loops, showing the variation of magnetization, M, as a function of applied magnetic field, H, qualitatively illustrate the corresponding hysteresis losses of the compounds with and without the Fe metal additive in the 260-320 K temperature range. The magnetization versus field loops were obtained by isothermally measuring the magnetization as a function of applied field from 260 to 320 K, at each 10 K interval.

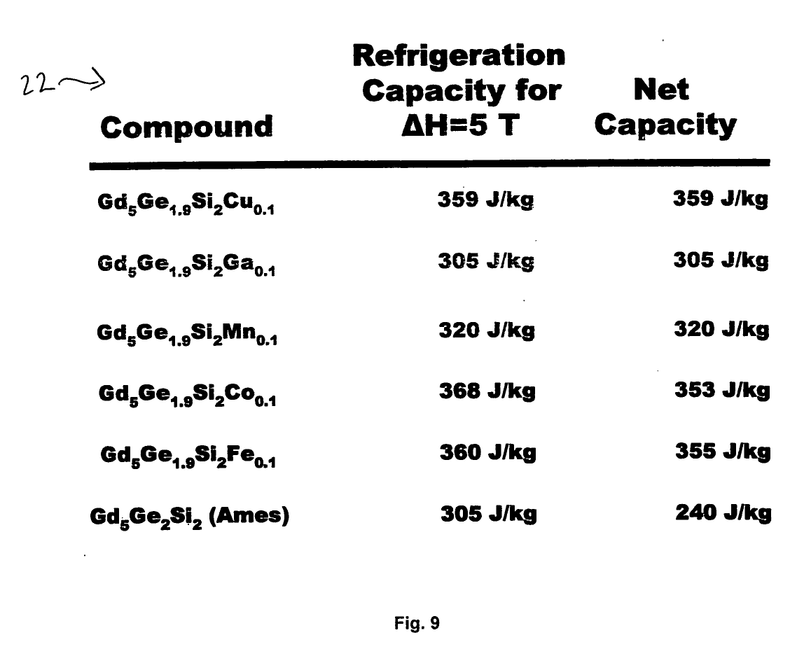

For each loop, the field was cycled from zero to 5 T and back zero. The hysteretic loss values summarized in Table 22 of FIG. 9 provide a quantitative comparison for the metal additive-free alloy and alloys with the Fe metal additive. These hysteresis loss values were determined by computing the area inside each magnetization versus field loop. From this comparison, it can be clearly seen that the addition of about one atom percent iron to the Gd₅Ge₂Si₂ alloy resulted in a reduction of the hysteresis losses by more than 90 percent compared to the alloy without any metal additives.

Alloy samples with metal additives other than iron were also prepared according to different embodiments. Gd₅Ge₂Si₂ compounds alloyed or doped with Co, Cu, Ga, or Mn metal additives were prepared in the same manner as the Gd₅Ge_{1.9}Si₂Fe_{0.1}, i.e. by arc melting the appropriate elemental mixtures, using a water-cooled copper hearth in an argon atmosphere under ambient pressure. Approximately one atomic percent of the metal additive was added to the Gd₅Ge₂Si₂ compound. The purity of the starting constituents was 99.9 wt. % and the chemical compositions of the alloy samples were as follows: Gd₅Ge_{1.9}Si₂Co_{0.1}, Gd₅Ge_{1.9}Si₂Cu_{0.1}, Gd₅Ge_{1.9}Si₂Ga_{0.1}, and Gd₅Ge_{1.9}Si₂Mn_{0.1} As in the case of the Gd₅Ge_{1.9}Si₂Fe_{0.1} alloy of the first embodiment, each alloy was homogenized for one hour at 1300° C. in vacuum prior to making magnetic measurements using a SQUID magnetometer.

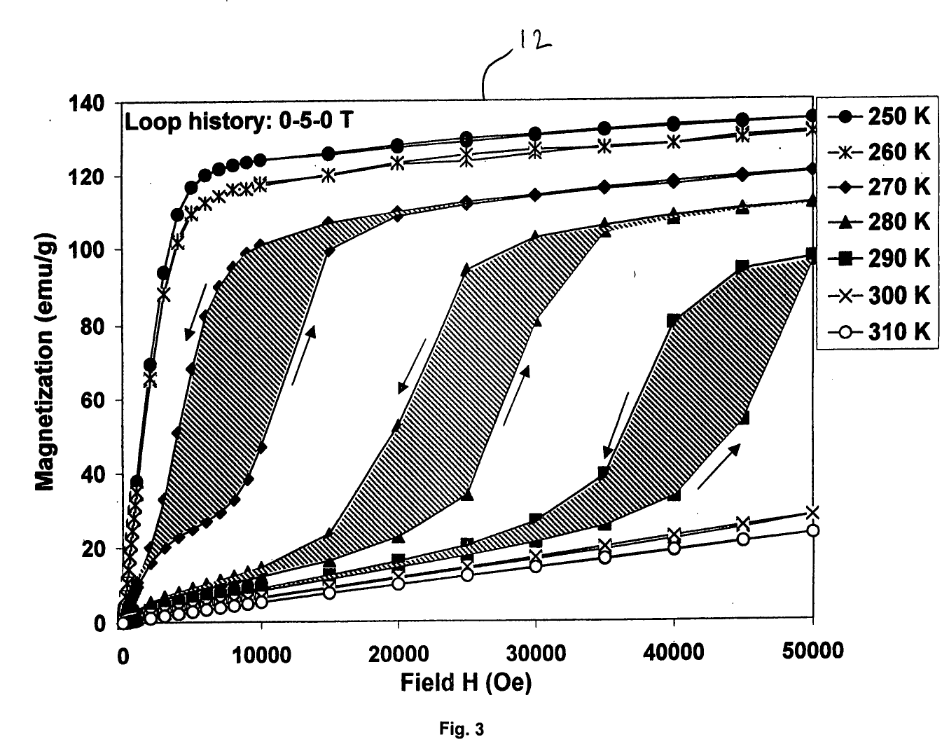

Referring to FIGS. 2 (a)-(d), which, respectively, depict backscattered SEM micrographs of the heat treated Gd₅Ge₂Si₂ compound doped with cobalt, copper, gallium and manganese 14, 15, 16, 17, the Gd₅Ge₂Si₂ compounds doped with the metal additives have a microstructure consisting of a brighter dominant matrix phase and a darker minor phase delineating the grain boundaries of the matrix phase unlike the undoped single phase Gd₅Ge₂Si₂ compound 10 (FIG. 1).

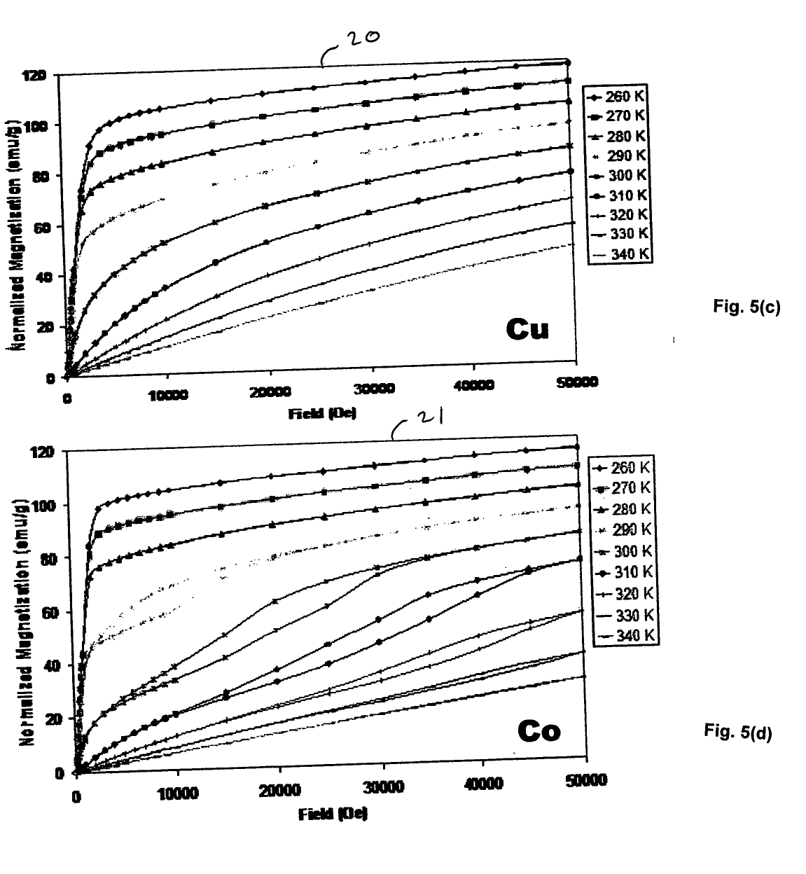

Referring to FIGS. 5(a)-(d), which, respectively, depict sets of hysterisis loops 18, 19, 20, 21 showing the variation of magnetization, M, as a function of applied magnetic field, H, for the Gd₅Ge_{1.9}Si₂Mn_{0.1} 17, Gd₅Ge_{1.9}Si₂Ga_{0.1} 16, Gd₅Ge_{1.9}Si₂Cu_{0.1} 15, and Gd₅Ge_{1.9}Si₂Co_{0.1} 14 compounds, these Figures qualitatively illustrate the corresponding hysteresis losses of the compounds with the metal additives in the 260-320 K temperature range. The magnetization versus field loops 18, 19, 20, 21 for these alloys were obtained in the same way as for the Gd₅Ge_{1.9}Si₂Fe_{0.1} compound by isothermally measuring the magnetization as a function of applied field from 260 to 320 K, at each 10 K interval. For each loop, the field was cycled from zero to 5 T and back zero.

The hysteretic loss values summarized in the Table 22 provide a quantitative comparison for the metal additive-free alloy and alloys with the metal additives. From this comparison, it can be clearly seen that the addition of about one atom percent of silicide-forming metals to the Gd₅Ge₂Si₂ alloy resulted in a reduction of the hysteresis losses by more than 90 percent compared to the alloy without any metal additives and, for the metal additives Mn, Cu, and Ga the hysteresis losses were nearly or completely eliminated, that is the reduction was nearly 100 percent.

Additional insight concerning the effect of the silicide forming metals on the magnetocaloric response of the Gd₅Ge₂Si₂ compound in the 270-320 K temperature range can be obtained by examination of the magnetization versus field loops shown in FIGS. 3, 4 and 5(a)-5(d). For the undoped Gd₅Ge₂Si₂ alloy 10 containing no metal additive (FIG. 3), the magnetization versus field loops 12 show a distinct magnetic transition with increasing field for all temperatures between 270-290 K. Note that this transition occurs at higher field values with increasing temperature. Gschneidner and Pecharsky and their coworkers at Ames Laboratory hypothesized that this transition is the result of a field-induced first order magnetic transition from the paramagnetic monoclinic phase to the ferromagnetic orthorhombic phase. The magnetization versus field loops 12 appear to show that this field-induced transition is reversible upon decreasing field. However, the field at which the reversed transition occurs is smaller than the field required for inducing the original transition. Below 270 K the alloy is ferromagnetic and above 295 K the material is paramagnetic.

By contrast, the magnetization versus field loops 13 of the alloy 11 containing iron (FIG. 4) do not show any field-induced magnetic transition in the 260-320 K temperature range for fields up to 5 T. In this temperature range, in fact, the magnetic data show a gradual shift from a ferromagnetic behavior to superparamagnetic behavior at about 300 K up to up to 320 K; above 320 K the material becomes paramagnetic. As already discussed, the compound without any metal additive becomes paramagnetic above 290 K. In addition, the M versus H data for the quaternary alloys do not indicate the presence of any magnetic transition for T<260 K. Therefore, the behavior of the alloys with and without the metal additives strongly suggests that one of the main effects of either iron or the other silicide-forming metal additives is to suppress the monoclinic-to-orthorhombic field-induced phase transition in the 270-320 K range, resulting in much smaller hysteresis losses.

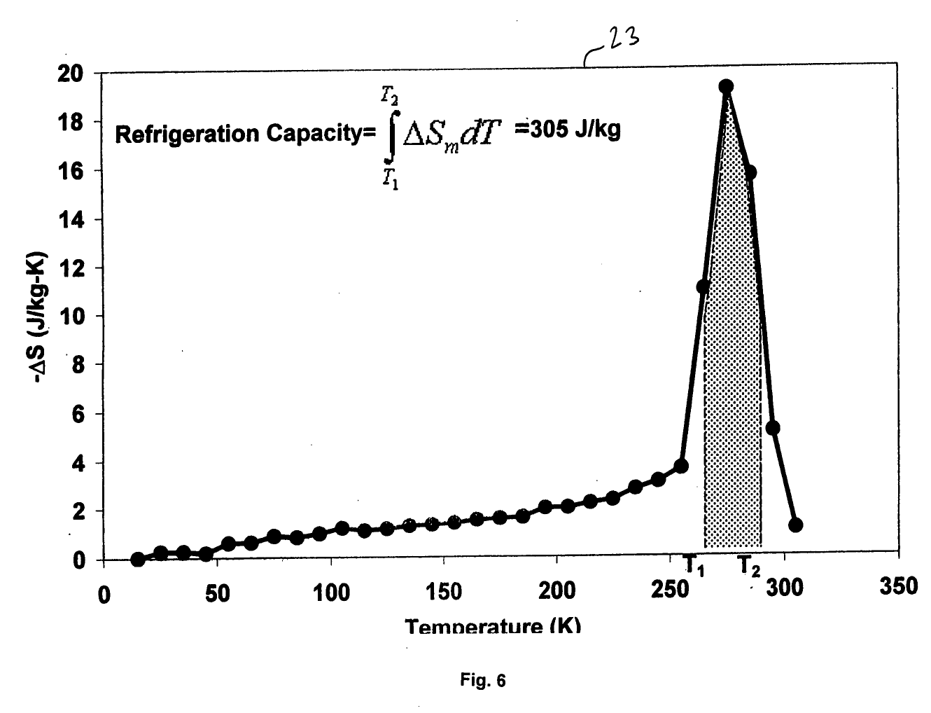

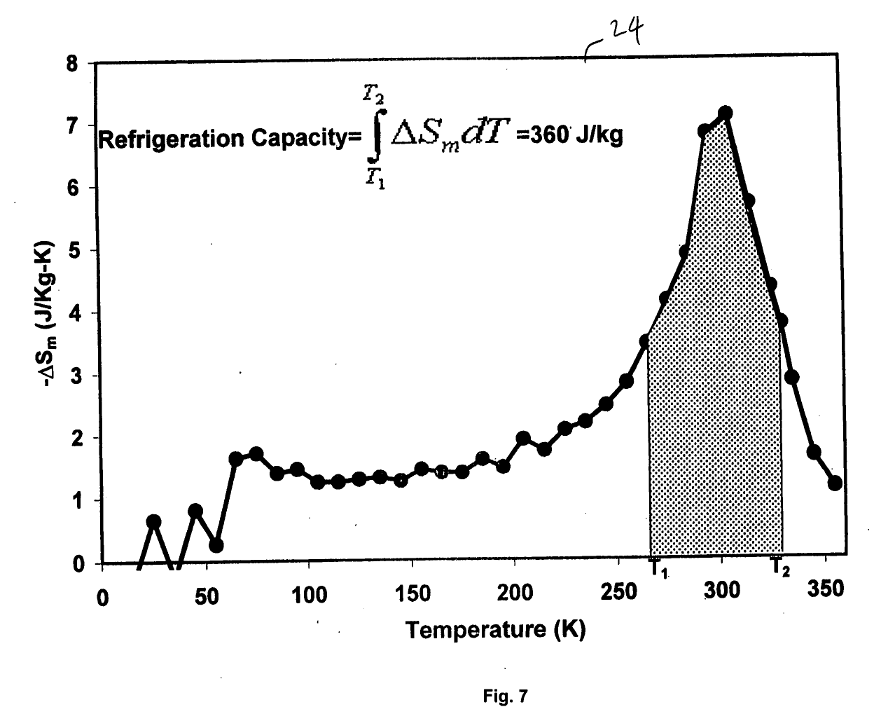

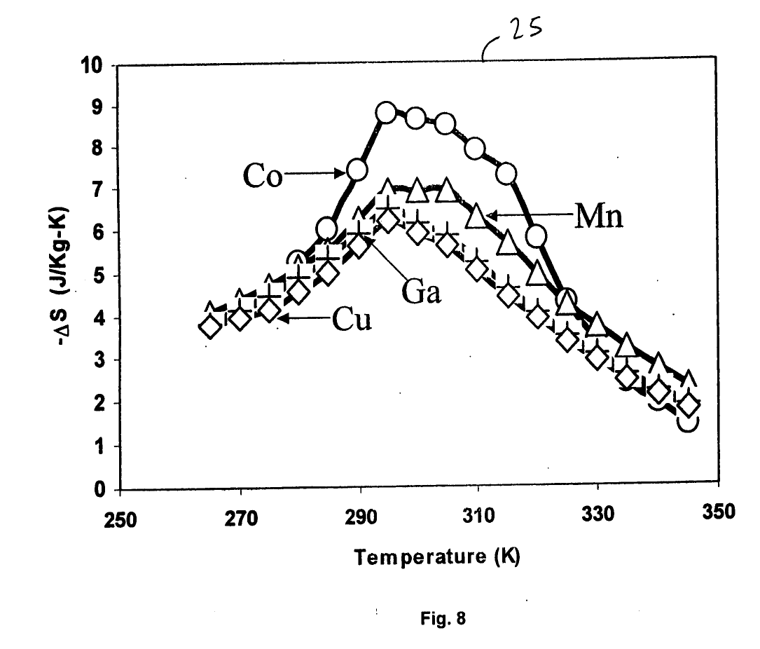

Referring to FIGS. 6 and 7, which, respectively, depict graphs 23, 24 of computed magnetic entropy change, ΔSₘ, versus temperature of the heat treated Gd₅Ge₂Si₂ compound and the heat treated Gd₅Ge_{1.9}Si₂Fe_{0.1} alloy, variation of the magnetic entropy change, ΔSₘ, with temperature for the metal additive-free alloy and alloy with iron additive is observed. Also, variation of the magnetic entropy change for the alloys with other metal additives is also observed as shown in FIG. 8, which depicts a graph 25 of computed magnetic entropy change, ΔSₘ, versus temperature of the different heat treated Gd₅Ge_{1.9}Si₂Co_{0.1} 14, Gd₅Ge_{1.9}Si₂Mn_{0.1} 17, Gd₅Ge_{1.9}Si₂Cu_{0.1} 15, Gd₅Ge_{1.9}Si₂Ga_{0.1} 16, alloys of the embodiments. These data were computed from the isothermal M vs. H data of the alloys, using the integrated form of the Maxwell relation and a numerical integration routine.

The data presented in FIGS. 6-8 clearly show the following significant differences regarding the magnetic entropy change, ΔSₘ, as a function of temperature for the alloy without and the alloys with the metal additives. First, for the alloy without any metal additives, the value of the ΔSₘ peak, integrated over an applied field, ΔH=5 T, is about a factor of 3 higher than of the alloys with the metal additives (20 J/kg-K vs. 7 J/kg-K). Secondly, the ΔSₘ peaks for the metal additive-containing alloys are considerable broader (FIGS. 7 and 8). Thirdly, the peak of ΔSₘ occurs at about 305 K for these latter alloys, whereas in the alloy without the metal additives the ΔSm peak occurs at about 275 K.

From the data presented in FIGS. 6-8, the refrigeration capacity value was computed for each alloy. The refrigeration capacity RC values were computed by numerically integrating the areas under the ΔSₘ vs. temperature curves, using the temperatures at the half maximum of the ΔSₘ peak as the integration limits. Table 22 of FIG. 9 shows computed Refrigeration Capacity (RC) values for the compound Gd₅Ge₂Si₂ and for the compound Gd₅Ge₂Si₂ doped with the different metal additives according to the embodiments.

A measure of the usefulness of the alloys with and without metal additives as potential magnetic refrigerants is indicated by subtracting from the refrigeration capacity values the corresponding average hysteresis losses and thus obtaining a net or effective refrigeration capacity (NRC): NRC=RC-average hysteresis loss. These hysteresis losses are very small (approximately 4 J/kg or less) and large (around 65 J/kg) for the alloys with and without metal additives, respectively, in the range of temperature where the RC values were computed.

The resulting NRC values are also given in Table 22 of FIG. 9. The significantly higher NRC values and much smaller hysteretic losses of the compounds Gd₅Ge₂Si₂ doped with the different metal additives according to the embodiments, clearly demonstrate that the alloys with the silicide-forming metal additives are significantly superior as magnetic refrigerants for near-room temperature refrigeration applications, compared to the alloy without any such metal additives. Adding a silicide-forming metal to the Gd₅Ge₂Si₂ compound therefore provides a magnetic refrigerant material highly suitable for near-room temperature applications.

It would be reasonable to conclude that the same mechanism that gives rise to the unusually large magnetocaloric effect is also responsible for the large hysteresis losses: namely, the field-induced crystallographic phase change.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method of reducing hysteretic losses in a Gd₅Ge₂Si₂ refrigerant compound comprising providing the Gd₅Ge₂Si₂ compound, and doping or alloying said Gd₅Ge₂Si₂ compound with an effective amount of silicide-forming metal element such that the hysterisis losses in said doped Gd₅Ge₂Si₂ compound are substantially reduced in comparison to the hysterisis losses of said undoped Gd₅Ge₂Si₂ compound.

2. The method of claim 1, wherein doping said Gd₅Ge₂Si₂ compound comprises adding about one atomic percent of said silicide-forming metal to said compound.

3. The method of claim 2, wherein said silicide-forming metal element comprises at least one metal selected from a group comprising at least one of the following: Fe, Co, Mn, Cu, or Ga.

4. The method of claim 1, wherein said silicide-forming metal element comprises at least one metal selected from a group comprising at least one of the following: Fe, Co, Mn, Cu, or Ga.

5. The method of claim 1, wherein the method of providing said Gd₅Ge₂Si₂ compound comprises: arc melting mixtures of said compound elements.

6. The method of claim 5, wherein the method of doping or alloying said Gd₅Ge₂Si₂ compound comprises: arc melting mixtures of the silicide-forming metal element with said compound elements.

7. The method of 1, further comprising heat-treating said doped compound so as to homogenize said doped compound.

8. A method of preparing a refrigerant compound comprising
forming a Gd₅Ge₂Si₂ compound, and
doping or alloying said Gd₅Ge₂Si₂ compound with about 1 atomic percent of a silicide-forming metal element.

9. The method of claim 8, wherein said silicide-forming metal element comprises at least one metal selected from a group comprising at least one of the following: Fe, Co, Mn, Cu, or Ga.

10. The method of claim 8, wherein the method of forming said Gd₅Ge₂Si₂ compound comprises: arc melting mixtures of said compound elements in an argon atmosphere at atmospheric pressure.

11. The method of claim 10, wherein doping or alloying said Gd₅Ge₂Si₂ compound comprises: arc melting mixtures of silicide-forming metal element with said compound elements in an argon atmosphere at atmospheric pressure.

12. The method of claim 8, further comprising heat treating said doped Gd₅Ge₂Si₂ compound in a vacuum so as to homogenize said doped compound.

13. A doped Gd₅Ge₂Si₂ compound formed by the method of claim 1.

14. A magnetic refrigerant alloy of the general formula:
Gd₅Ge_{2-X}Si₂M_{X},
wherein M is a silicide-forming metal element; and
wherein x is an effective number selected such that hysterisis loss in the alloy is substantially smaller than when x=0.

15. The alloy of claim 14, wherein x is about 0.1.

16. The alloy of claim 15, wherein M is at least one metal selected from a group comprising at least one of the following: Fe, Co, Mn, Cu, or Ga.

17. The alloy of claim 14, wherein M is at least one metal selected from a group comprising at least one of the following: Fe, Co, Mn, Cu, or Ga.

18. The alloy of claim 14, wherein said alloy is homogenized by heat treatment.

19. The alloy of claim 18, wherein said alloy is heated at 1300° C.

20. The alloy of claim 19, wherein said alloy is heat treated for 1 hour.
